(19) United States
(12) Patent Application Publication
(10) Pub. No.: US 2016/0165426 A1
(43) Pub. Date: Jun. 9, 2016

(54) MOBILE COMMUNICATION SYSTEM, USER TERMINALS AND NETWORK DEVICES

(71) Applicant: KYOCERA CORPORATION, Kyoto (JP)

(72) Inventors: Chiharu YAMAZAKI, Ota-ku, Tokyo (JP); Kugo MORITA, Yokohama-shi, Kanagawa (JP); Masato FUJISHIRO, Yokohama-shi, Kanagawa (JP)

(73) Assignee: KYOCERA CORPORATION, Kyoto (JP)

(21) Appl. No.: 14/903,696

(22) PCT Filed: Jul. 8, 2014
(86) PCT No.: PCT/JP2014/068152

§ 371 Date: Jan. 8, 2016

(30) Foreign Application Priority Data
Jul. 9, 2013 (JP) 2013-144024

(51) Int. Cl. H04W 8/00; H04W 48/16

(52) U.S. Cl. CPC H04W 8/005; H04W 48/16

(57) ABSTRACT

A user terminal sets desired terminal information for designating a desired user terminal that is desired to be a communication partner of D2D communication, and the user terminal limits scanning of a discovery signal until determining that the desired terminal information is included in the discovery signal information notified from a network apparatus.

### TECHNICAL FIELD

The present invention relates to a mobile communication system that supports D2D communication, a user terminal thereof, and a network apparatus thereof.

### BACKGROUND ART

In 3GPP (3rd Generation Partnership Project) which is a project aiming to standardize a mobile communication system, the introduction of Device-to-Device (D2D) communication is discussed as a new function after Release 12 (see Non Patent Literature 1).

In the D2D communication, a plurality of nearby user terminals perform direct Device-to-Device communication without passing through a network. On the other hand, in cellular communication which is normal communication in a mobile communication system, a user terminal performs communication through a network.

### CITATION LIST

### Non Patent Literature

[NPL 1] 3GPP Technical Report “TR 22.803 V12.1.0”

### SUMMARY OF INVENTION

To discover a different user terminal, a user terminal performs scanning of a discovery signal that is used for discovering a partner terminal of D2D communication and that is transmitted from the different user terminal.

However, the user terminal does not know a situation of the different user terminal, and thus, for example, when there the different user terminal does not exist in an area where the user terminal exists, or when the different user terminal does not transmit a discovery signal, the user terminal may consume a battery wastefully by performing the scanning of a discovery signal.

Therefore, an object of the present invention is to provide a mobile communication system, a user terminal, and a network apparatus, with which it is possible to restrain wasteful battery consumption in D2D communication.

A mobile communication system according to one embodiment is a mobile communication system that supports D2D communication that is direct Device-to-Device communication. The mobile communication system comprises a user terminal that controls scanning of a discovery signal used for discovering a partner terminal of the D2D communication; and a network apparatus that notifies the user terminal of discovery signal information on a different user terminal that transmits the discovery signal within an area where the user terminal exists. The user terminal sets desired terminal information for designating a desired user terminal that is desired to be a communication partner of the D2D communication, and the user terminal limits scanning of the discovery signal until determining that the desired terminal information is included in the discovery signal information notified from the network apparatus.

### BRIEF DESCRIPTION OF DRAWINGS

FIG. 1 is a configuration diagram of an LTE system.

FIG. 2 is a block diagram of a UE.

FIG. 3 is a block diagram of an eNB.

FIG. 4 is a protocol stack diagram of a radio interface in the LTE system.

FIG. 5 is a configuration diagram of a radio frame used in the LTE system.

FIG. 6 is a diagram for describing D2D communication.

FIG. 7 is an explanatory diagram for describing an operation environment of a mobile communication system according to a first embodiment.

FIG. 8 is a sequence diagram showing an operation example of the mobile communication system according to the present embodiment.

FIG. 9 is a sequence diagram showing an operation example of the mobile communication system according to the present embodiment.

FIG. 10 is a sequence diagram showing an operation pattern 1 that is an operation example of a mobile communication system according to a modification of the first embodiment.

FIG. 11 is a sequence diagram showing an operation pattern 2 that is an operation example of the mobile communication system according to the modification of the first embodiment.

FIG. 12 is an explanatory diagram for describing an operation environment of a mobile communication system according to a second embodiment.

FIG. 13 is a sequence diagram showing an operation example of the mobile communication system according to the present embodiment.

FIG. 14 is a sequence diagram showing an operation example of the mobile communication system according to the present embodiment.

FIG. 15 is a sequence diagram showing an operation example of a mobile communication system according to anther embodiment.

FIG. 16 is a sequence diagram showing an operation example of the mobile communication system according to the other embodiment.

FIG. 17 is an explanatory diagram for describing an operation example in which a candidate list is updated.

### DESCRIPTION OF EMBODIMENT

A mobile communication system according to the embodiments is a mobile communication system that supports D2D communication that is direct Device-to-Device communication. The mobile communication system comprises: a user terminal that controls scanning of a discovery signal used for discovering a partner terminal of the D2D communication; and a network apparatus that notifies the user terminal of discovery signal information on a different user terminal that transmits the discovery signal within an area where the user terminal exists. The user terminal sets desired terminal information for designating a desired user terminal that is desired to be a communication partner of the D2D communication, and the user terminal limits scanning of the discovery signal until determining that the desired terminal information is included in the discovery signal information notified from the network apparatus.

In a first embodiment, the user terminal sets, as the desired terminal information, an application identifier indicating an application used for the D2D communication, and when an application identifier that is included in the discovery signal information and that indicates an application used by the different user terminal for the D2D communication matches the application identifier that is set, the user terminal determines that the desired terminal information is included in the discovery signal information.

In a second embodiment, the user terminal sets, as the desired terminal information, a unique identifier indicating the desired user terminal, the user terminal notifies the network apparatus of the unique identifier indicating the desired user terminal as the desired terminal information, and when the unique identifier acquired by the desired terminal information matches an identifier indicating the different user terminal that transmits the discovery signal, the network apparatus notifies the user terminal of information related to the different user terminal as the discovery signal information, and/or, when the unique identifier acquired by the desired terminal information does not match the identifier indicating the different user terminal that transmits the discovery signal, notifies the user terminal of information indicating that a desired user terminal does not match the different user terminal.

In the second embodiment, the different user terminal notifies the network apparatus of a whitelist relating to an accepted user terminal that is accepted to be discovered as a communication partner of the D2D communication, and only when the user terminal that notifies the desired terminal information is the accepted user terminal included in the whitelist, the network apparatus notifies the user terminal of information relating to the different user terminal as the discovery signal information.

In the second embodiment, the different user terminal notifies the network apparatus of a blacklist relating to a refused user terminal that is refused to be discovered as a communication partner of the D2D communication, and when the user terminal that notifies the desired terminal information is the refused user terminal included in the blacklist, the network apparatus does not notify the user terminal of information relating to the different user terminal as the discovery signal information.

In the second embodiment, the different user terminal notifies the network apparatus fact that the communication partner of the D2D communication is not limited to a specific user terminal, and even when the unique identifier acquired by the desired terminal information does not match the identifier indicating the different user terminal that transmits the discovery signal, the network apparatus notifies the user terminal of information relating to the different user terminal as the discovery signal information.

In the second embodiment, the user terminal notifies the network apparatus of a unique identifier indicating the desired user terminal, the network apparatus transmits a temporary user identifier temporarily assigned as an identifier indicating the different user terminal, which is included in the discovery signal information, when receiving the discovery signal from the different user terminal through scanning of the discovery signal and the temporary user identifier corresponding to the discovery signal is designated on the basis of the discovery signal information, the user terminal notifies the network apparatus of the temporary user identifier, and when a unique identifier of the different user terminal to which the temporary user identifier is assigned matches a unique identifier indicating the desired user terminal, the network apparatus notifies the user terminal of an instruction to start the D2D communication, and/or, when a unique identifier of the different user terminal to which the temporary user identifier is assigned does not match a unique identifier indicating the desired user terminal, the network apparatus notifies the user terminal of information indicating that the unique identifier of the different user terminal does not match the unique identifier indicating the desired user terminal.

In a modification of first embodiment, the user terminal notifies the network apparatus of a unique identifier indicating the desired user terminal, the different user terminal transmits a temporary user identifier temporarily assigned as an identifier indicating the different user terminal, which is included into the discovery signal, when receiving the discovery signal including the temporary user identifier from the different user terminal through scanning of the discovery signal, the user terminal notifies the network apparatus of the temporary user identifier, and when a unique identifier of the different user terminal to which the temporary user identifier is assigned matches a unique identifier indicating the desired user terminal, the network apparatus notifies the user terminal of an instruction to start the D2D communication, and/or, when a unique identifier of the different user terminal to which the temporary user identifier is assigned does not match a unique identifier indicating the desired user terminal, the network apparatus notifies the user terminal of information indicating that the unique identifier of the different user terminal does not match the unique identifier indicating the desired user terminal.

In the modification of first embodiment, when receiving the discovery signal from the different user terminal through scanning of the discovery signal, the user terminal notifies the network apparatus of a fact that the discovery signal is received, the network apparatus that receives the fact that the discovery signal is received notifies the user terminal and the different user terminal of a radio resource assigned to the user terminal and the different user terminal, and the user terminal and the different user terminal confirm whether or not to start the D2D communication by using the radio resource.

In the modification of first embodiment, the network apparatus determines, on the basis of an application used by the different user terminal for the D2D communication, whether or not to notify the user terminal and the different user terminal of the radio resource.

In a modification of other embodiments, the user terminal sets, as the desired terminal information, a unique identifier that indicates the different user terminal and that is known by the user terminal, the different user terminal transmits the unique identifier that indicates the different user terminal and that is known by the user terminal, which is included in the discovery signal, and when the unique identifier included in the discovery signal matches the unique identifier set as the desired terminal information, the user terminal determines that the different user terminal that transmits the discovery signal is the desired user terminal.

A user terminal according to the embodiments is a user terminal in a mobile communication system that has a network apparatus and that supports D2D communication that is direct Device-to-Device communication. The user terminal comprises: a controller configured to control scanning of a discovery signal used for discovering a partner terminal of the D2D communication; and a receiver configured to receive, from the network apparatus, discovery signal information on a different user terminal that transmits the discovery signal within an area where the user terminal exists. The controller sets desired terminal information for designating a desired user terminal that is desired to be a communication partner of the D2D communication. The controller limits scanning of the discovery signal until the user terminal determines that the desired terminal information is included in the discovery signal information notified from the network apparatus.

In the first embodiment, the controller sets, as the desired terminal information, an application identifier indicating an application used for the D2D communication. When an application identifier that is included in the discovery signal information and that indicates an application used by the different user terminal for the D2D communication matches the application identifier that is set, the controller determines that the desired terminal information is included in the discovery signal information.

The user terminal according to the first embodiment further comprises a transmitter configured to notify the network apparatus of the unique identifier indicating the desired user terminal as the desired terminal information, when the unique identifier acquired by the desired terminal information matches an identifier indicating the different user terminal that transmits the discovery signal, the receiver receives from the network apparatus information relating to the different user terminal as the discovery signal information and/or, when the unique identifier acquired by the desired terminal information does not match the identifier indicating the different user terminal that transmits the discovery signal, receives, from the network apparatus, information indicating that the desired user terminal does not match the different user terminal as the discovery signal information.

A network apparatus according to the embodiments is a network apparatus in a mobile communication system that has a user terminal and that supports D2D communication that is direct device-to-device communication. The network apparatus comprises a transmitter configured to notify the user terminal of discovery signal information on a different user terminal that transmits the discovery signal within an area where the user terminal exists. The discovery signal information is used by the user terminal to determine whether or not a desired user terminal that is desired by the user terminal to be a communication partner of the D2D communication transmits the discovery signal within the area.

In the network apparatus according to the first embodiment, the transmitter notifies the user terminal of the discovery signal information including an application identifier indicating an application used by the different user terminal for the D2D communication, and the application identifier included in the discovery signal information is used by the user terminal to determine whether or not the application used by the different user terminal for the D2D communication matches the application used by the user terminal for the D2D communication.

The network apparatus according to the first embodiment comprises: a receiver configured to receive a unique identifier indicating the desired user terminal from the user terminal; and a controller configured to control to, when the unique identifier indicating the desired user terminal matches an identifier indicating the different user terminal that transmits the discovery signal, notify the user terminal of information related to the different user terminal as the discovery signal information, and/or, when the unique identifier acquired by the desired terminal information does not match the identifier indicating the different user terminal that transmits the discovery signal, notify the user terminal of information indicating that a desired user terminal does not match the different user terminal, as the discovery signal information.

It is noted that the user terminal according to the second embodiment further comprises a transmitter configured to notify the network apparatus of a unique identifier indicating the desired user terminal. When receiving the discovery signal including a temporary user identifier temporarily assigned as an identifier indicating the different user terminal from the different user terminal through scanning of the discovery signal, the transmitter notifies the network apparatus of the temporary user identifier. When a unique identifier of the different user terminal to which the temporary user identifier is assigned matches a unique identifier indicating the desired user terminal, the receiver receives, from the network apparatus, an instruction to starting the D2D communication.

Furthermore, the user terminal according to the second embodiment further comprises a transmitter configured to notify the network apparatus, when receiving the discovery signal from the different user terminal through scanning of the discovery signal, of fact that the discovery signal is received. The receiver receives a radio resource assigned to the user terminal and the different user terminal. The controller confirms whether or not to start the D2D communication between the user terminal and the different user terminal.

Furthermore, in the user terminal according to the second embodiment, the controller sets, as the desired terminal information, a unique identifier that indicates the different user terminal and that is known by the user terminal. The receiver receives, from the different user terminal, the discovery signal including the unique identifier that indicates the different user terminal and that is known by the user terminal. When the unique identifier included in the discovery signal matches the unique identifier set as the desired terminal information, the controller determines that the different user terminal that transmits the discovery signal is the desired user terminal.

Furthermore, the network apparatus according to the second embodiment further comprises: a receiver configured to receive, from the user terminal, a unique identifier indicating the desired user terminal; and a controller configured to temporarily assign a temporary user identifier as an identifier indicating the different user terminal. The receiver receives, from the user terminal, the temporary user identifier included in the discovery signal, and when a unique identifier of the different user terminal to which the temporary user identifier is assigned matches a unique identifier indicating the desired user terminal, the controller controls to notifies the user terminal of an instruction to start the D2D communication.

Furthermore, the network apparatus according to the second embodiment comprises a receiver configured to receive, from the user terminal, fact that the discovery signal is received. When the receiver receives the fact that the discovery signal is received, the transmitter notifies the user terminal and the different user terminal of a radio resource assigned to the user terminal and the different user terminal.

Furthermore, the network apparatus according to the second embodiment further comprises a controller configured to determines whether or not to notify the user terminal and the different user terminal of the radio resource on the basis of an application used by the different user terminal for the D2D communication.

It is noted that the above-described claim-based “network apparatus” includes an eNB 200.

### First Embodiment

### LTE System

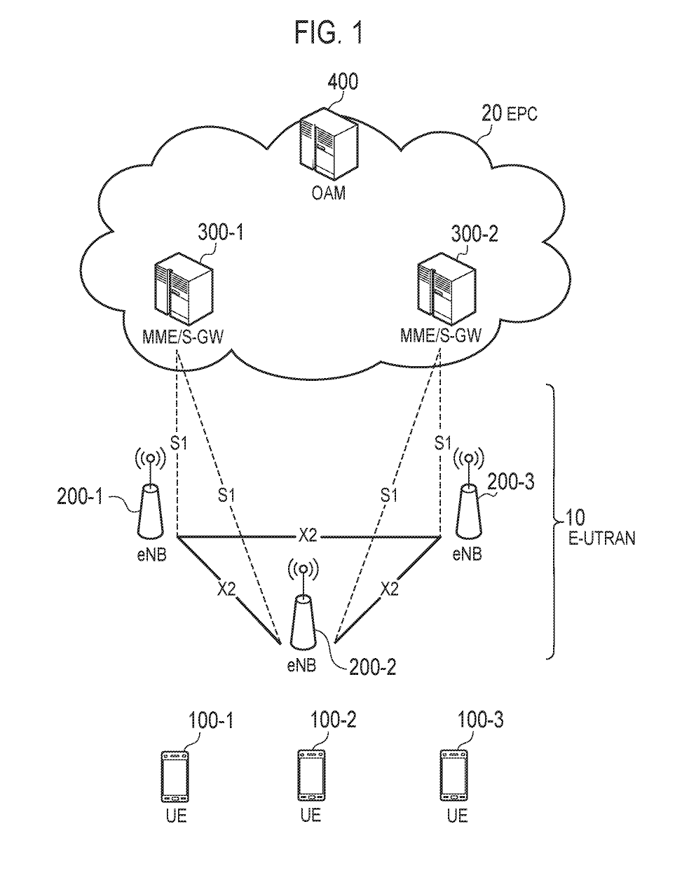

FIG. 1 is a configuration diagram of an LTE system according to the present embodiment.

As shown in FIG. 1, the LTE system includes a plurality of UEs (User Equipments) 100, an E-UTRAN (Evolved Universal Terrestrial Radio Access Network) 10, and an EPC (Evolved Packet Core) 20. The E-UTRAN 10 and the EPC 20 configure a network.

The UE 100 is a mobile-type radio communication device and performs radio communication with a cell (serving cell) with which a connection is established. The UE 100 corresponds to a user terminal.

The E-UTRAN 10 includes a plurality of eNBs 200 (evolved Node-Bs). The eNB 200 corresponds to a base station. The eNB 200 manages a cell and performs radio communication with the UE 100 that establishes a connection with the cell.

It is noted that the “cell” is used as a term indicating a minimum unit of a radio communication area, and is also used as a term indicating a function of performing radio communication with the UE 100.

The eNB 200, for example, has a radio resource management (RRM) function, a routing function for user data, and a measurement control function for mobility control and scheduling.

The EPC 20 includes an MME (Mobility Management Entity)/S-GW (Serving-Gateway) 300, and an OAM 400 (Operation and Maintenance). Further, the EPC 20 corresponds to a core network.

The MME is a network node that performs various mobility controls, etc., on the UE 100, and corresponds to a control station. The S-GW is a network node that performs control to transfer user data and corresponds to a mobile switching center.

The eNBs 200 are connected mutually via an X2 interface. Further, the eNB 200 is connected to the MME/S-GW 300 via an S1 interface.

The OAM 400 is a server device managed by an operator and performs maintenance and monitoring of the E-UTRAN 10.

Next, the configurations of the UE 100 and the eNB 200 will be described.

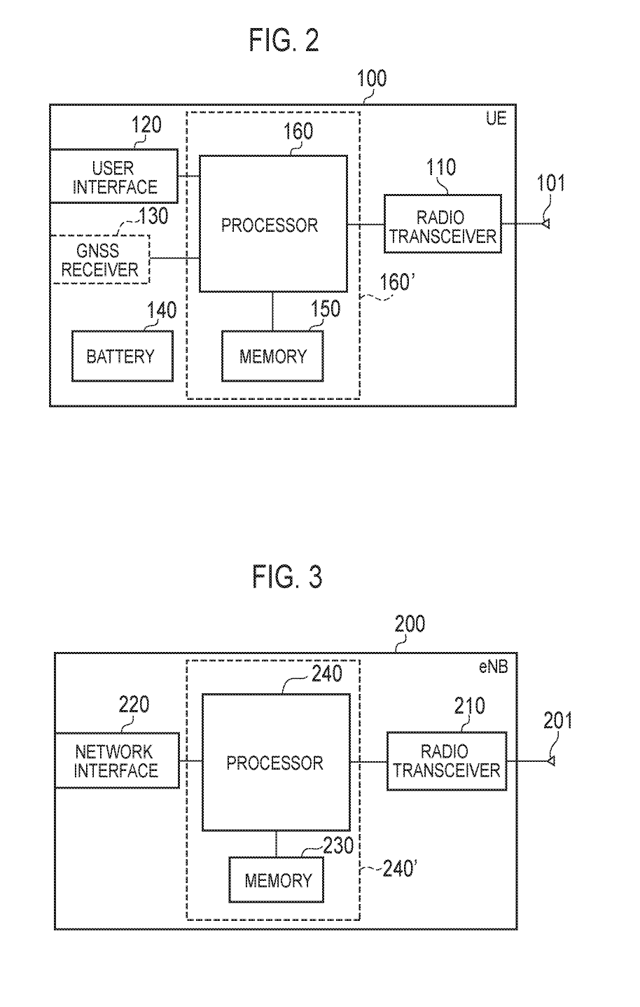

FIG. 2 is a block diagram of the UE 100. As shown in FIG. 2, the UE 100 includes an antenna 101, a radio transceiver 110, a user interface 120, a GNSS (Global Navigation Satellite System) receiver 130, a battery 140, a memory 150, and a processor 160. The memory 150 and the processor 160 configure a controller.

A controller of the present embodiment controls transmission of a discovery signal (Discovery signal) used for discovering a partner terminal of the D2D communication. Further, the controller controls scanning of the discovery signal. Specifically, the controller limits the scanning of the discovery signal until it is determined that information of designating a desired UE is included in discovery signal information.

The UE 100 may not have the GNSS receiver 130. Furthermore, the memory 150 may be integrally formed with the processor 160, and this set (that is, a chipset) may be called a processor 160′.

The antenna 101 and the radio transceiver 110 are used to transmit and receive a radio signal. The antenna 101 includes a plurality of antenna elements. The radio transceiver 110 converts a baseband signal output from the processor 160 into the radio signal, and transmits the radio signal from the antenna 101. Furthermore, the radio transceiver 110 converts the radio signal received by the antenna 101 into the baseband signal, and outputs the baseband signal to the processor 160.

The user interface 120 is an interface with a user carrying the UE 100, and includes, for example, a display, a microphone, a speaker, and various buttons. The user interface 120 receives an operation from a user and outputs a signal indicating the content of the operation to the processor 160.

The GNSS receiver 130 receives a GNSS signal in order to obtain location information indicating a geographical location of the UE 100, and outputs the received signal to the processor 160.

The battery 140 accumulates a power to be supplied to each block of the UE 100.

The memory 150 stores a program to be executed by the processor 160 and information to be used for a process by the processor 160.

The processor 160 includes a baseband processor that performs modulation and demodulation, encoding and decoding and the like of the baseband signal, and a CPU (Central Processing Unit) that performs various processes by executing the program stored in the memory 150. The processor 160 may further include a codec that performs coding and decoding of sound and video signals. The processor 160 implements various processes and various communication protocols described later.

FIG. 3 is a block diagram of the eNB 200. As illustrated in FIG. 3, the eNB 200 includes an antenna 201, a radio transceiver 210, a network interface 220, a memory 230, and a processor 240. The memory 230 and the processor 240 constitute a control unit. It is noted that the memory 230 may be integrally formed with the processor 240, and this set (that is, a chipset) may be called a processor 240′.

The antenna 201 and the radio transceiver 210 are used to transmit and receive a radio signal. The antenna 201 includes a plurality of antenna elements. The radio transceiver 210 converts the baseband signal output from the processor 240 into the radio signal, and transmits the radio signal from the antenna 201. Furthermore, the radio transceiver 210 converts the radio signal received by the antenna 201 into the baseband signal, and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240.

The processor 240 includes the baseband processor that performs modulation and demodulation, encoding and decoding and the like of the baseband signal and a CPU that performs various processes by executing the program stored in the memory 230. The processor 240 implements various processes and various communication protocols described later.

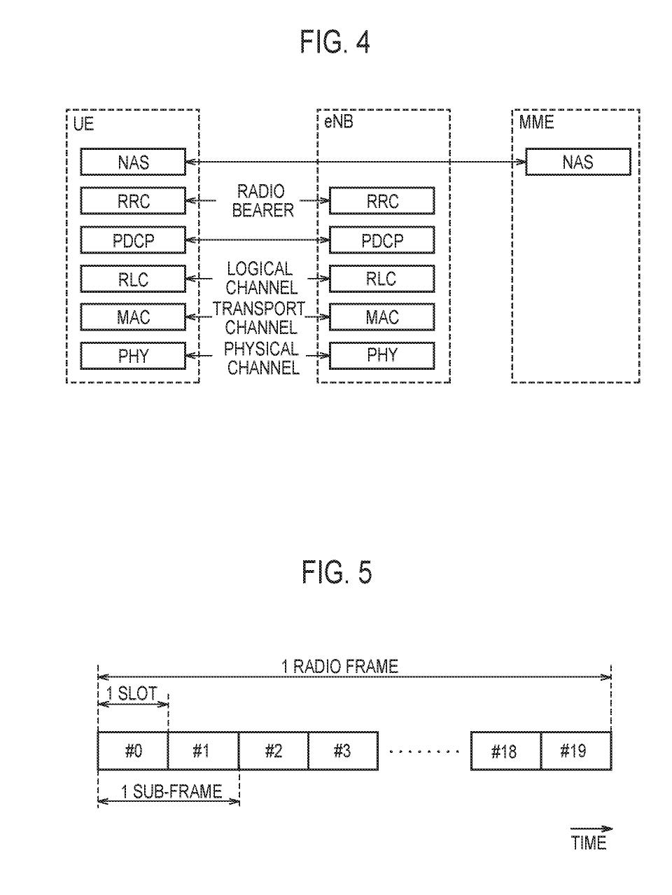

FIG. 4 is a protocol stack diagram of a radio interface in the LTE system.

As illustrated in FIG. 4, the radio interface protocol is classified into a layer 1 to a layer 3 of an OSI reference model, wherein the layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, data is transmitted via the physical channel.

The MAC layer performs preferential control of data, and a retransmission process and the like by hybrid ARQ (an HARQ). Between the MAC layer of the UE 100 and the MAC layer of the eNB 200, data is transmitted via a transport channel. The MAC layer of the eNB 200 includes a scheduler that determines an uplink and downlink transport format (a transport block size, a modulation and coding scheme and the like) and an assignment resource block.

The RLC layer transmits data to an RLC layer of a reception side by using the functions of the MAC layer and the PHY layer. Between the RLC layer of the UE 100 and the RLC layer of the eNB 200, data is transmitted via a logical channel.

The PDCP layer performs header compression and decompression, and encryption and decryption.

The RRC layer is defined only in a control plane. Between the RRC layer of the UE 100 and the RRC layer of the eNB 200, a control message (an RRC message) for various types of setting is transmitted. The RRC layer controls the logical channel, the transport channel, and the physical channel in response to establishment, re-establishment, and release of a radio bearer. When an RRC connection is established between the RRC of the UE 100 and the RRC of the eNB 200, the UE 100 is in a connection state, and when the RRC connection is not established, the UE 100 is in an idle state.

A NAS (Non-Access Stratum) layer positioned above the RRC layer performs session management or mobility management.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each symbol is provided at a head thereof with a guard interval called a cyclic prefix (CP). The resource block includes a plurality of subcarriers in the frequency direction. A radio resource unit configured by one subcarrier and one symbol is called a resource element (RE).

Among radio resources assigned to the UE 100, a frequency resource can be designated by a resource block and a time resource can be designated by a subframe (or slot).

In the downlink, an interval of several symbols at the head of each subframe is a control region mainly used as a physical downlink control channel (PDCCH). Furthermore, the other interval of each subframe is a region mainly used as a physical downlink shared channel (PDSCH). Moreover, in each subframe, cell-specific reference signals (CRSs) are distributed and arranged.

In the uplink, both ends in the frequency direction of each subframe are control regions mainly used as a physical uplink control channel (PUCCH). Furthermore, the center portion in the frequency direction of each subframe is a region mainly used as a physical uplink shared channel (PUSCH). Moreover, in each subframe, a demodulation reference signal (DMRS) and a sounding reference signal (SRS) are arranged.

(D2D Communication)

The LTE system according to the embodiment supports D2D communication that is direct Device-to-Device communication (UE-to-UE communication). Here, the D2D communication is described in comparison with cellular communication that is normal communication of the LTE system. The cellular communication is a communication mode in which a data path passes through a network (E-UTRAN 10, EPC 20). The data path is a communication path for user data. On the other hand, the D2D communication is a communication mode in which a data path set between UEs does not pass through the network.

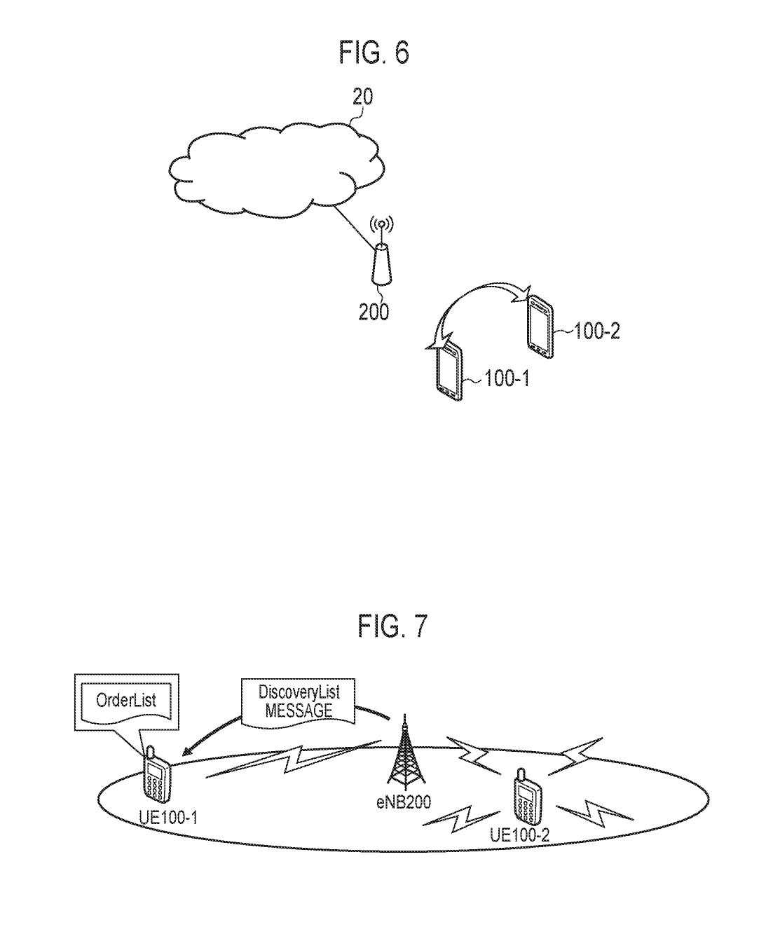

FIG. 6 is a diagram for describing the D2D communication. As shown in FIG. 6, in the D2D communication, a data path does not pass through the eNB 200. A UE 100-1 and a UE 100-2 adjacent to each other directly perform radio communication with low transmission power in a cell of the eNB 200. Thus, when the adjacent UE 100-1 and UE 100-2 directly perform radio communication with low transmission power, it is possible to reduce a power consumption of the UE 100 and to reduce interference to a neighboring cell, in comparison with in the cellular communication.

(Discovery List)

The eNB 200 has a discovery list (Discovery List) regarding a UE 100 that transmits a discovery signal within its own cell managed by the eNB 200.

The discovery list includes information on a unique identifier (a unique UEID, a telephone number, and a mail address, for example) indicating the UE 100 that transmits the discovery signal, a discovery code (DiscoveryCode) that is a code for identifying the discovery signal, and an identifier (application ID) of an application used by the UE 100 that transmits the discovery signal in the D2D communication.

The discovery code includes at least either one of a unique identifier (UEID) previously set to the UE 100 itself, an identifier (a telephone number, for example) upper than the UEID, an identifier (RNTI) temporarily assigned to be controlled by the eNB 200, and a sequence of the discovery signal, for example.

It is noted that when a user of a UE 100 that transmits the discovery signal uses the D2D communication for a commercial purpose, the application identifier may include an identifier for identifying each shop (or each service) in addition to the identifier indicating the application. In other words, a dedicated activation software may be made to correspond to the application identifier at each shop (or in each service), or a set of an activation software common to each shop (or each service) and a shop identifier may be made to correspond to the application identifier.

Further, the discovery list may include at least any one information of: a temporary UE 100 identifier (TemporaryUEID) temporarily assigned as an identifier indicating the UE 100 that transmits the discovery signal, a radio resource used for transmitting the discovery signal (a frequency band, for example), a transmission timing of the discovery signal, a content of an application used by the UE 100 that transmits the discovery signal for the D2D communication, a type of an identifier of an application (temporary identifier (TemporaryID) or a unique identifier (UniqueID)), information on an application, information for distinguishing an accepted UE which is accepted by the UE 100 that transmits the discovery signal to be discovered as a communication partner of the D2D communication (whitelist), information for distinguishing a refused UE which is refused by the UE 100 that transmits the discovery signal to be discovered as the communication partner of the D2D communication (blacklist), and OpenDiscovery information.

The temporary UE 100 identifier is an identifier temporarily assigned to the UE 100 in order that the eNB 200 (or a network 500) manages the UE 100 that transmits the discovery signal.

The type of an identifier of an application indicates that the identifier of the application is a temporary identifier (TemporaryID) or a unique identifier (UniqueID)). The unique identifier is an identifier unique within PLMN, in a predetermined region (Region), in a country, or in the world.

The information on the application is information indicating whether or not the application needs a secondary discovery process described later, for example.

The OpenDiscovery information is information indicating that the UE 100 that transmits or receives the discovery signal does not consider that a discovery target or a communication target in the D2D communication is a specific UE 100. The OpenDiscovery information may be a flag indicating whether or not the UE 100 that transmits or receives the discovery signal is subject to OpenDiscovery.

In the present embodiment, a UE 100 registered in the discovery list is a UE 100 that exists in the cell managed by the eNB 200. The eNB 200 may refer to at least any one of: an identifier of the UE 100, capability information (Capability Information) on the D2D communication of the UE 100, information (ON/OFF information) indicating whether or not the D2D communication of the UE 100 is effective, and information (Discoverable related information) related to a discovery of the communication partner of the D2D communication so as to register the information on the UE 100 in the discovery list. The eNB 200 may acquire the information registered in the discovery list from the UE 100, and may acquire from the network 500.

It is noted that when a UE 100 requests a registration in the discovery list, the eNB 200 may register the UE 100 in the discovery list.

(Operation Environment of Mobile Communication System)

Next, by using FIG. 7, an operation environment of the mobile communication system according to the present embodiment will be described. FIG. 7 is an explanatory diagram for describing the operation environment of the mobile communication system according to the present embodiment.

As shown in FIG. 7, the UEs 100 (a UE 100-1 and a UE 100-2) exist in a cell managed by the eNB 200.

The UE 100-1 sets information for specifying a desired UE that is desired as a communication partner of the D2D communication, to a candidate list (OrderList).

The information set to the candidate list may be an identifier (a unique UEID, a telephone number, and a mail address, for example) indicating the desired UE 100 or an application identifier (application ID) used for the D2D communication, for example.

When the identifier indicating the application is set to the candidate list, the UE 100-1 may set, to the candidate list, software for activating the set application (activation application) and an execution option on the execution of the set application. It is noted that the execution option is used to correspond to a case where the application identifier indicates the software, for example, and in addition, where the shop identifier is included.

As shown in FIG. 7, on the basis of the discovery list, the eNB 200 notifies the UE 100-1 that exists in its own cell of discovery signal information (DiscoveryListMessage).

The discovery signal information (DiscoveryListMessage) is information on the UE 100-2 that transmits the discovery signal within an area where the UE 100-1 exists. Specifically, discovery signal information (DiscoveryListMessage) is information on the UE 100-2 registered in the discovery list. The discovery signal information may be part of information on the UE 100-2 registered in the discovery list and may include all the information on the UE 100-2. Further, the discovery signal information may include information related to the radio resource transmitted by the UE 100-2 (Discovery-resource-related information).

(Schematic Operation of Mobile Communication System)

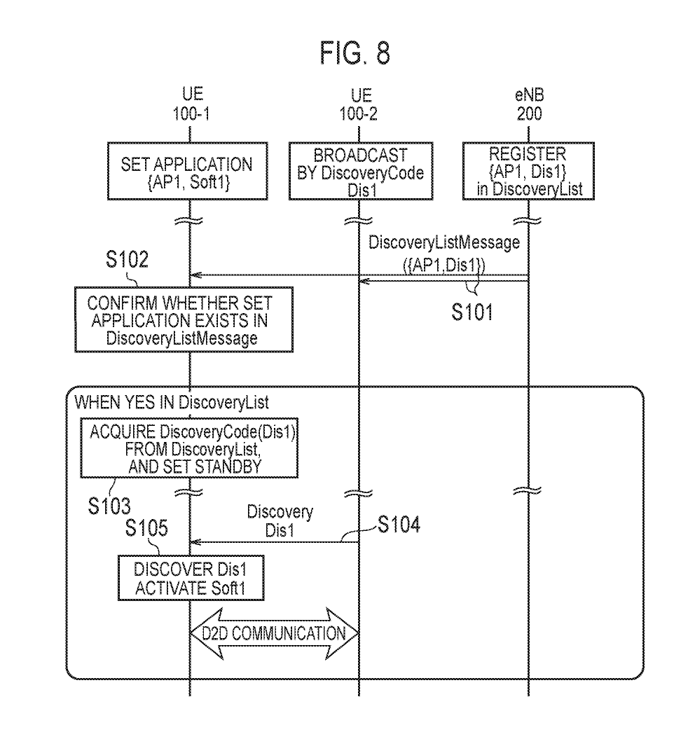

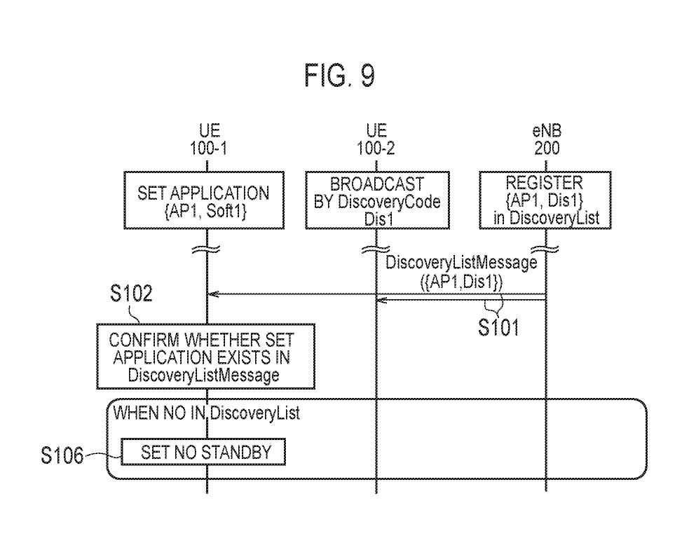

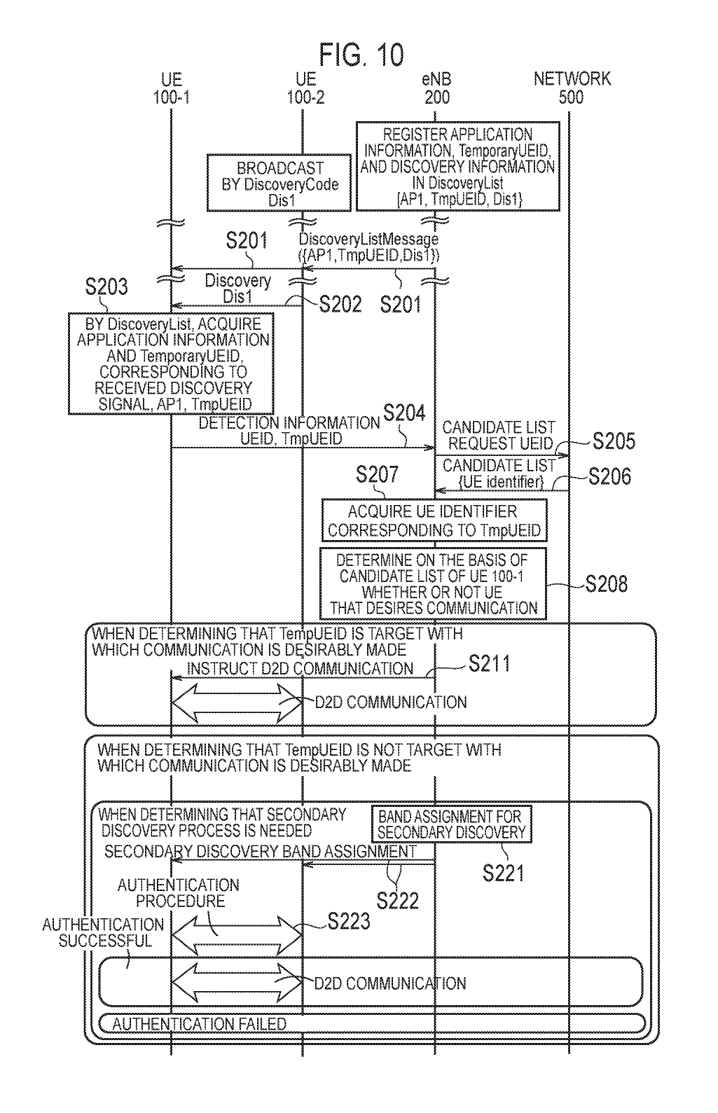

Next, a schematic operation of the mobile communication system according to the present embodiment will be described by using FIG. 8 and FIG. 9. FIG. 8 and FIG. 9 are sequence diagrams showing an operation example of the mobile communication system according to the present embodiment.

As shown in FIG. 8, a user of the UE 100-1 sets an application used for the D2D communication. As a result, the UE 100-1 sets (registers), to the candidate list, an application identifier AP1 and a software Soft1 used for the D2D communication. The UE 100-2 starts broadcasting the discovery signal including a discovery code Dis1. The eNB 200 registers, to the discovery list, the application identifier AP1 and the discovery code Dis1 included in the discovery signal transmitted by the UE 100-2. The eNB 200 may previously acquire a content registered in the discovery list from the UE 100-2, and may acquire the content from the network.

In the UE 100-1, the scanning of the discovery signal is limited. Specifically, the UE 100-1 does not perform the scanning of the discovery signal.

In step 101, the eNB 200 notifies the discovery signal information (DiscoveryListMessage). Each of the UE 100-1 and the UE 100-2 receives the discovery signal information.

The eNB 200 broadcasts the discovery signal information by including the discovery signal information into a system information block (SIB), notifies the discovery signal information by an RRC signaling, and multicasts the discovery signal information by using MBMS (Multimedia Broadcast and Multicast Service), for example.

In the present embodiment, the discovery signal information includes the application identifier AP1 and the discovery code Dis1 used by the UE 100-2 for the D2D communication.

In step 102, the UE 100-1 confirms whether or not the set application exists in the discovery signal information. The UE 100-1 determines whether or not the application identifier AP1 set to the candidate list is included in the discovery signal information. In the present embodiment, the application identifier AP1 is included in the discovery signal information, and thus, the UE 100-1 executes a process in step 103.

In step 103, there is the application identifier AP1 in the discovery signal information, and thus, the UE 100-1 acquires the discovery code Dis1 from the discovery signal information, and on the basis of the discovery code Dis1, performs a standby setting for starting the scanning of the discovery signal. The UE 100-1 starts the scanning of the discovery signal upon completion of the standby setting. That is, the UE 100-1 releases the limitation of the scanning of the discovery signal.

In step 104, the UE 100-2 broadcasts the discovery signal including the discovery code Dis1. The UE 100-1 receives the discovery signal through the scanning of the discovery signal.

In step 105, the UE 100-1 discovers the discovery code Dis1 through receiving the discovery signal. Thus, the UE 100-1 discovers the UE 100-2 that acts as a communication partner of the D2D communication. The UE 100-1 that discovers the UE 100-2 activates the software Soft1.

After the software Soft1 is activated, the UE 100-1 establishes a connection for the D2D communication with the UE 100-2, and the UE 100-1 and the UE 100-2 start the D2D communication.

On the other hand, as shown in FIG. 9, when setting an application identifier AP2 and a software Soft2 to the candidate list instead of the application identifier AP1 and the software Soft1 used for the D2D communication, the UE 100-1 determines in step 102 that the application identifier AP2 set to the candidate list is not included in the discovery signal information. In this case, the UE 100-1 performs a process in step 106.

In step 106, the UE 100-1 does not start the scanning of the discovery signal, and thus, performs a setting to not stand by the discovery signal. Therefore, in the UE 100-1, the scanning of the discovery signal is still limited.

### Modification of First Embodiment

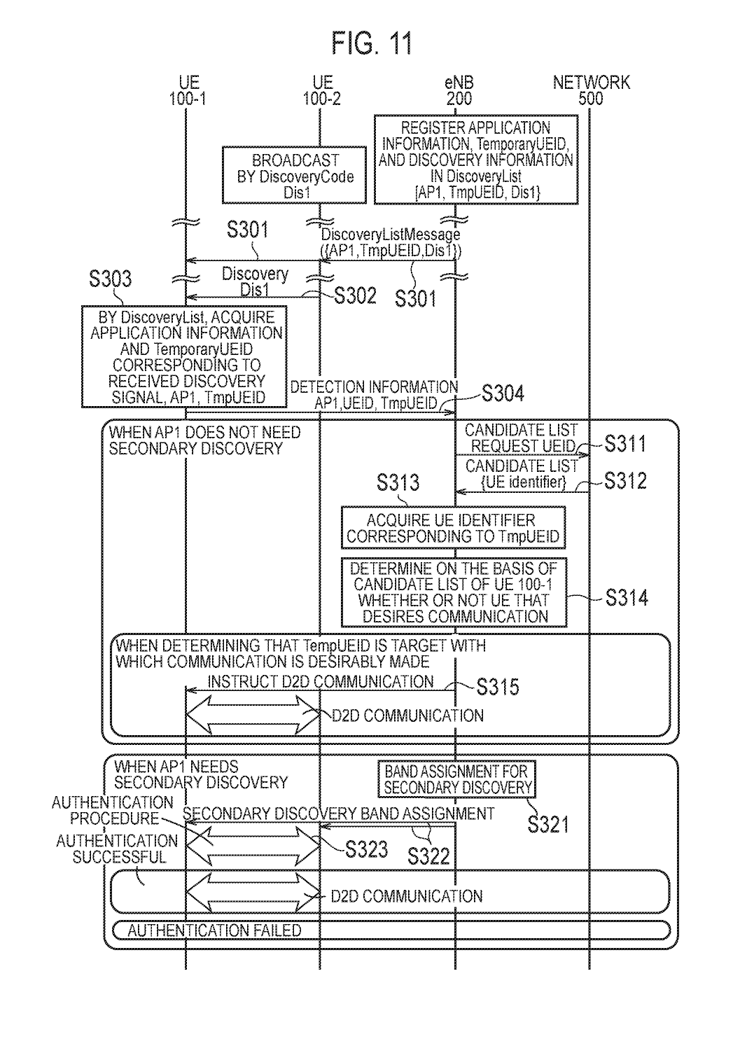

Next, by using FIG. 10 and FIG. 11, a mobile communication system according to a modification of the first embodiment will be described.

FIG. 10 is a sequence diagram showing an operation pattern 1 that is an operation example of the mobile communication system according to the modification of the first embodiment. FIG. 11 is a sequence diagram showing an operation pattern 2 that is an operation example of the mobile communication system according to the modification of the first embodiment.

In the above-described embodiment, the UE 100-1 performs the D2D communication after receiving the discovery signal; however, in the present modification, the UE 100-1 receives an instruction of the D2D communication from the eNB 200 after receiving the discovery signal.

It is noted that a description will be provided while focusing on a portion different from the above-described embodiment, and a description of a similar portion will be omitted, where necessary.

In the present modification, in accordance with the determination by the eNB 200, the following operation patterns 1 and 2 are performed.

(1) Operation Pattern 1

Firstly, the operation pattern 1 will be described by using FIG. 10.

The UE 100-1 previously notifies the network 500 of the UE identifier that is a unique identifier indicating a desired UE. The network 500 has a candidate list in which the UE identifier indicating the desired UE of the UE 100-1 is registered.

As shown in FIG. 10, the UE 100-2 starts broadcasting the discovery signal including the discovery code Dis1. The eNB 200 registers an application identifier AP1, a temporary UE identifier (TemporaryUEID: TmpUEID) of the UE 100-2, and a discovery code Dis1 included in the discovery signal transmitted by the UE 100-2. It is noted that the UE 100-1 sets the application identifier AP1 to the candidate list.

In step 201, the eNB 200 broadcasts the discovery signal information. Each of the UE 100-1 and the UE 100-2 receives the discovery signal information.

In the present embodiment, the discovery signal information includes, in addition to the application identifier AP1 and the discovery code Dis1, the temporary UE identifier.

The UE 100-1 sets the application identifier AP1 to the candidate list, and there is the application identifier AP1 in the discovery signal information, and thus, acquires the discovery code Dis1 from the discovery signal information, and on the basis of the discovery code Dis1, starts the scanning of the discovery signal.

In step 202, the UE 100-2 broadcasts the discovery signal including the discovery code Dis1. The UE 100-1 receives the discovery signal through the scanning of the discovery signal.

In step S203, the UE 100-1 acquires the application identifier AP1 and the temporary UE identifier corresponding to the discovery code Dis1, from the discovery signal information. As a result, the UE 100-1 designates the temporary UE identifier corresponding to the received discovery signal.

In step 204, the UE 100-1 notifies the eNB 200 of detection information indicating detection of the discovery signal. The eNB 200 receives the detection information.

The UE 100-1 is not capable of determining as to whether or not the desired UE that the UE 100-1 desires has the temporary UE identifier, and thus, the UE 100-1 notifies the eNB 200 of the detection information in order to inquire the eNB 200 or the network 500. The detection information includes the identifier of the UE 100-1 and the temporary UE identifier corresponding to the discovery signal.

In step 205, the eNB 200 that receives the detection information notifies the network 500 of a candidate list request. The network 500 receives the candidate list request.

The candidate list request includes the identifier of the UE 100-1 included in the detection information.

In step 206, the network 500 transmits the candidate list to the eNB 200. The eNB 200 receives the candidate list.

The network 500 transmits, on the basis of the identifier of the UE 100-1 included in the candidate list request, the candidate list of the UE 100-1, to the eNB 200. In the candidate list, the UE identifier indicating the desired UE is registered.

In step 207, the eNB 200 acquires the UE identifier corresponding to the temporary UE identifier. The eNB 200 acquires the unique UE identifier corresponding to the temporary UE identifier from a memory 230 of the eNB 200 or the network 500.

In step 208, the eNB 200 determines on the basis of the candidate list of the UE 100-1 whether or not the UE 100-2 that transmits the discovery signal received by the UE 100-1 is the desired UE. That is, the eNB 200 determines whether or not the unique UE identifier corresponding to the temporary UE identifier matches the UE identifier registered in the candidate list of the UE 100-1.

When determining that these UE identifiers match each other, that is, when determining that the temporary UE identifier is an UE identifier of the UE with which the UE 100-1 intends to communicate, the eNB 200 executes a process in step 211.

In step 211, the eNB 200 transmits an instruction of the D2D communication to the UE 100-1. The UE 100-1 receives the instruction of the D2D communication. The UE 100-1 that receives the instruction of the D2D communication starts the D2D communication with the UE 100-2.

On the other hand, when determining that these UE identifiers do not match each other, the eNB 200 further determines whether or not a secondary discovery process is needed. The eNB 200 determines that the secondary discovery process is needed when the UE 100-2 that transmits the discovery signal requests the secondary discovery process, for example. When determining that the secondary discovery process is needed, the eNB 200 executes a process in step 221.

In step 221, the eNB 200 performs the band assignment for performing the secondary discovery process. In addition to step 202, the eNB 200 assigns the radio resource to the UE 100-1 and the UE 100-2 in order that the UE 100-1 and the UE 100-2 exchange the discovery signal.

In step 222, the eNB 200 notifies each of the UE 100-1 and the UE 100-2 of the band assignment. Each of the UE 100-1 and the UE 100-2 receives the band assignment.

In step 223, each of the UE 100-1 and the UE 100-2 uses the band assignment to exchange the discovery signal. As a result, the UE 100-1 and the UE 100-2 confirm whether or not to start the D2D communication. The UE 100-1 and the UE 100-2 transmit an authentication key which is included into the discovery signal, for example. The UE 100-1 and the UE 100-2 mutually acquire the authentication key, and perform an authentication procedure for determining whether or not to start the D2D communication.

When mutually determining to start the D2D communication, each of the UE 100-1 and the UE 100-2 starts the D2D communication assuming that the authentication is successful. On the other hand, when at least either one of the UE 100-1 and the UE 100-2 determines to not start the D2D communication, the D2D communication is not performed assuming that the authentication is failed.

It is noted that when determining that the identifier is not the UE identifier of the UE with which the UE 100-1 intends to communicate, the eNB 200 does nothing, or notifies the UE 100-1 of information indicating that the UE 100-2 that transmits the received discovery signal is not the desired UE (that is, information indicating that the unique identifier of the UE 100-2 that transmits the received discovery signal does not match the unique identifier indicating the desired UE).

It is noted that as a modification of the operation pattern 2, the discovery signal information in step 201 may not include the temporary UE identifier of the UE 100-2, and the discovery signal in step 202 may include the temporary UE identifier of the UE 100-2.

In this case, in step 204, the UE 100-1 transmits to the eNB 200 the temporary UE identifier of the UE 100-2 included in the discovery signal.

(2) Operation Pattern 2

Next, the operation pattern 2 will be described using FIG. 11. It is noted that a description will be provided while focusing on a portion different from the above-described operation pattern 1, and a description of a similar portion will be omitted, where necessary.

Steps 301 to 303 correspond to steps 201 to 203.

In step 304, the UE 100-1 notifies the eNB 200 of the detection information in much the same way as in step 204.

In the operation pattern 2, the detection information includes, in addition to the identifier of the UE 100-1 and the temporary UE identifier corresponding to the discovery signal, the application identifier AP1 corresponding to the discovery code Dis1.

The eNB 200 determines on the basis of the application (application identifier AP1) whether or not the secondary discovery process is needed. The eNB 200 determines that the secondary discovery process is not needed, for example, when the application identifier AP1 indicates an application used when the communication partner of the D2D communication is not limited to a specific UE. The eNB 200 executes a process in step 311 when the eNB 200 determines that the application identifier AP1 does not need the secondary discovery process. On the other hand, the eNB 200 executes a process in step 321 when the eNB 200 determines that the application identifier AP1 needs the secondary discovery process.

Steps 311 to 315 correspond to steps 205 to 208 and 211, and steps 321 to 323 correspond to steps 221 to 223.

It is noted that as a modification of the operation pattern 2, when it is settled by the temporary UE identifier that the number of applications is one, the UE 100-1 does not need to include the application identifier into the detection information.

### Summary of First Embodiment

In the present embodiment, the eNB 200 broadcasts to the UE 100-1 the discovery signal information on the UE 100-2 that transmits the discovery signal within the cell in which the UE 100-1 exists. The UE 100-1 sets to the candidate list the application identifier for designating the desired UE desired to be the communication partner of the D2D communication, and the UE 100-1 limits the scanning of the discovery signal until it is determined that the set application identifier is included in the discovery signal information. As a result, when there is no UE 100-2 that transmits the discovery signal within an area in which the UE 100-1 exists, or when the UE 100-2 does not transmit the discovery signal, the scanning by the UE 100-1 of the discovery signal is limited. Therefore, the UE 100-1 is capable of restraining a wasteful battery consumption. Further, when the discovery signal information includes the radio resource (the frequency band, for example) used for transmitting the discovery signal, the UE 100-1 performs the scanning on the basis of the radio resource, whereby it is possible to avoid a situation where a frequency band not used for transmitting the discovery signal is scanned. As a result, the UE 100-1 is capable of restraining a wasteful battery consumption.

Further, in the present embodiment, the UE 100-1 sets, as the information indicating the desired UE, the application identifier to the candidate list. The UE 100-1 determines that the desired UE is included in the discovery signal information when the application identifier included in the discovery signal information matches the set application identifier. As a result, even when the identifier of the desired UE is not registered in the candidate list, it is possible to perform the D2D communication, and thus, it is possible to effectively utilize the D2D communication while restraining a wasteful battery consumption.

Further, in the modification, the UE 100-1 notifies the eNB 200 of the unique identifier indicating the desired UE. The eNB 200 transmits, as the identifier of the UE 100-2, the temporary UE identifier which is included into the discovery signal. The UE 100-1 notifies the eNB 200 of the temporary UE identifier when, through the scanning of the discovery signal, receiving the discovery signal from the UE 100-2 and designating the temporary UE identifier corresponding to the discovery signal on the basis of the discovery signal information. The eNB 200 notifies the UE 100-1 of an instruction allowing the UE 100-1 to start the D2D communication when the unique identifier of the UE 100-2 to which the temporary UE identifier is assigned matches the identifier of the desired UE, and/or notifies the UE 100-1 of information indicating that the unique identifier of the UE 100-2 that transmits the received discovery signal does not match the unique identifier indicating the desired UE when the unique identifier of the UE 100-2 to which the temporary UE identifier is assigned matches the identifier of the desired UE. Further, in the modification, the UE 100-2 transmits, as the identifier of the UE 100-2, the temporary UE identifier which is included into the discovery signal. The UE 100-1 notifies the eNB 200 of the temporary UE identifier when, through the scanning of the discovery signal, receiving the discovery signal including the temporary UE identifier from the UE 100-2. The eNB 200 notifies the UE 100-1 of an instruction allowing the UE 100-1 to start the D2D communication when the unique identifier of the UE 100-2 to which the temporary UE identifier is assigned matches the identifier of the desired UE, and/or notifies the UE 100-1 of information indicating that the unique identifier of the UE 100-2 that transmits the received discovery signal does not match the unique identifier indicating the desired UE when the unique identifier of the UE 100-2 to which the temporary UE identifier is assigned matches the identifier of the desired UE. As a result, even when the temporary UE identifier is assigned to the UE 100-2, the UE 100-1 is capable of performing the D2D communication on the basis of the instruction from the eNB 200, without determining whether or not the UE 100-2 that transmits the discovery signal is the desired UE. Therefore, the UE 100-1 is capable of restraining a wasteful battery consumption that may otherwise happen when the D2D communication is started while the UE 100-2 is not the desired UE.

Further, in the modification, the UE 100-1 notifies the eNB 200 of the discovery signal being received when, through the scanning of the discovery signal, receiving the discovery signal from the UE 100-2. The eNB 200 that receives the reception of the discovery signal notifies the UE 100-1 and the UE 100-2 of the radio resource assigned to the UE 100-1 and the UE 100-2. The UE 100-1 and the UE 100-2 confirm whether or not to start the D2D communication by using the radio resource. As a result, it is possible to start the D2D communication after knowing that the UE 100-1 and the UE 100-2 are the desired UEs each other.

Further, in the modification, the eNB 200 determines on the basis of the application used by the UE 100-2 for the D2D communication whether or not to notify the UE 100-1 and the UE 100-2 of the radio resource. As a result, it is possible to confirm whether or not to start the D2D communication by newly using the radio resource after determining whether or not to perform temporary D2D communication on the basis of the application, and thus, the UE 100-2 does not need to include the information for confirming whether or not to start the D2D communication, into the discovery signal. Therefore, it is possible to avoid a situation where an amount of information included in the discovery signal is huge, and thus, it is possible to avoid a depletion of a radio resource used for transmitting the discovery signal.

### Second Embodiment

Next, a mobile communication system according to a second embodiment will be described. It is noted that description will be provided while focusing a portion different from the above-described embodiment and modification, and description of a similar portion will be omitted, where necessary.

In the above-described first embodiment, the eNB 200 broadcasts the discovery signal information; however, in the present embodiment, the eNB 200 transmits to the UE 100-1 the discovery signal information customized for the UE 100-1.

(Operation Environment of Mobile Communication System)

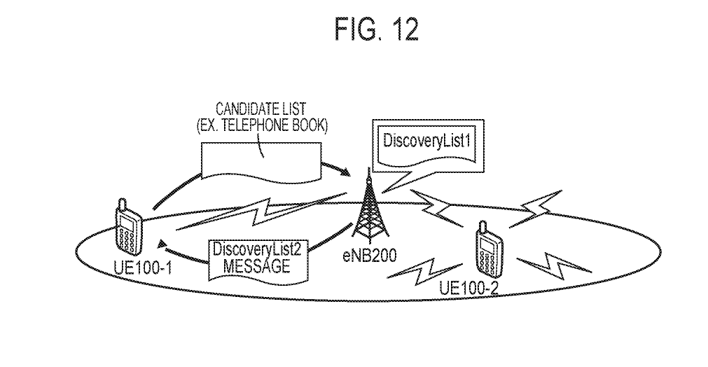

An operation environment of a mobile communication system according to the present embodiment will be described by using FIG. 12. FIG. 12 is an explanatory diagram for describing the operation environment of the mobile communication system according to the second embodiment.

As shown in FIG. 12, the UE 100-1 transmits the candidate list to the eNB 200. The candidate list is a telephone book in which a telephone number is registered, for example.

The eNB 200 determines whether or not the identifier (telephone number, for example) indicating the UE 100 included in the candidate list matches the identifier of the UE 100 that is registered in the discovery list (DiscoveryList1) and that transmits the discovery signal.

The eNB 200 transmits, as the discovery signal information (DiscoveryList2Message), the matched identifier of the UE 100, to the UE 100-1.

(Schematic Operation of Mobile Communication System)

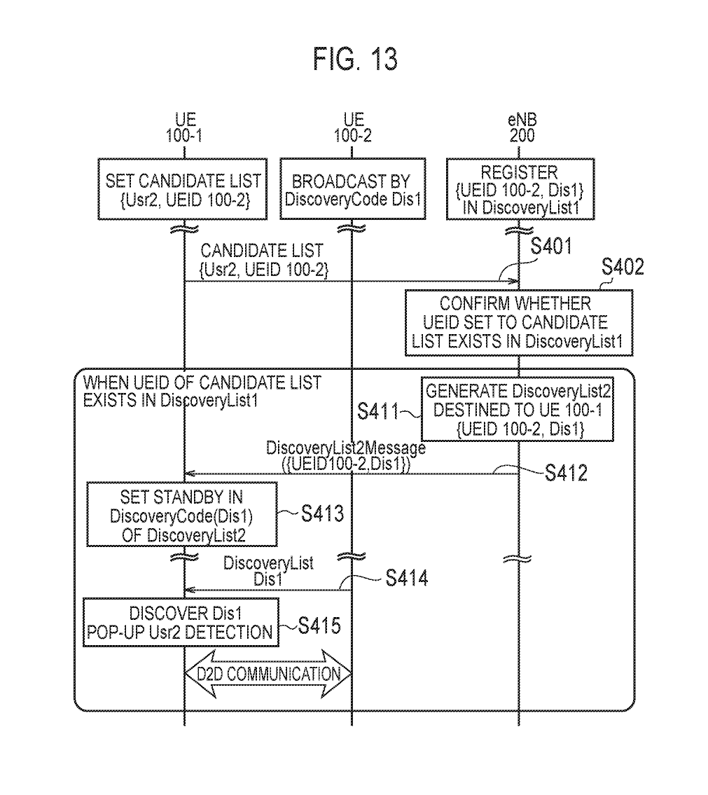

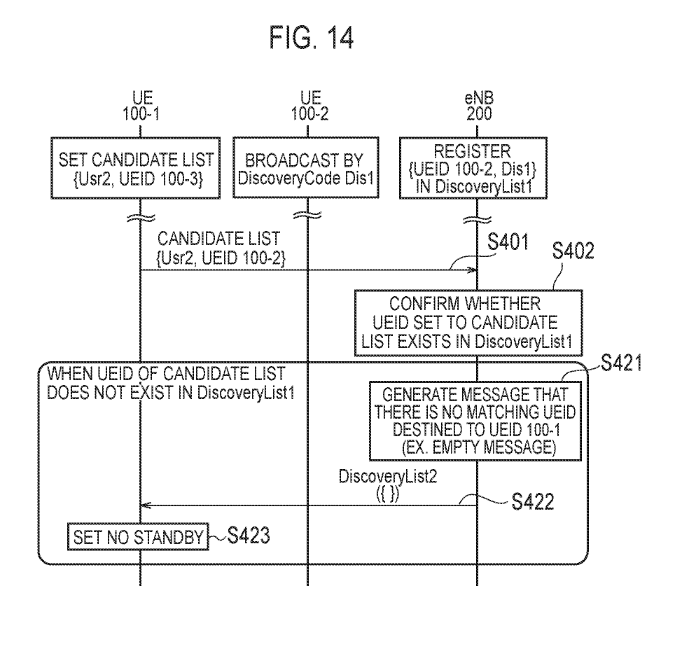

Next, a schematic operation of a mobile communication system according to the present embodiment will be described by using FIG. 13 and FIG. 14. FIG. 13 and FIG. 14 are sequence diagrams showing an operation example of the mobile communication system according to the present embodiment.

As shown in FIG. 13, a user of the UE 100-1 sets (registers) to the candidate list an identifier of a user Usr2 and an identifier UEID 100-2 of the UE 100-2 that is the UE held by the user Usr2. The UE 100-2 starts broadcasting the discovery signal including a discovery code Dis1. The eNB 200 registers to the discovery list (first discovery list) the identifier (UEID 100-2) of the UE 100-2 and the discovery code Dis1 included in the discovery signal transmitted by the UE 100-2.

In step 401, the UE 100-1 notifies the eNB 200 of the candidate list. The eNB 200 receives the candidate list. The candidate list includes the identifier of the user Usr2 and the identifier of the UE 100-2. It is noted that the candidate list may not need to include the identifier of the user Usr2.

In step 402, the eNB 200 confirms whether or not the identifier of the UE 100-2 set to the candidate list exists in the candidate list. That is, the eNB 200 determines whether or not the identifier of the UE 100-2 acquired by the candidate list matches the identifier of the UE 100-2 that transmits the discovery signal registered in the discovery list. In the present embodiment, the identifier of the UE 100-2 is registered to each of the discovery list and the candidate list, and thus, the eNB 200 determines that the two identifiers match. Therefore, the eNB 200 executes a process in step 411.

It is noted that when the UE 100-2 notifies the eNB 200 or the network 500 of the whitelist on the accepted UE that is accepted to be discovered as a partner of the D2D communication and the whitelist is registered in the discovery list, the eNB 200 may determine that the two identifiers match only when the UE 100-1 is the UE 100 included in the whitelist. That is, the eNB 200 may not execute the process in step 411 but may execute a process in step 421 described later even when the identifier of the UE 100-2 acquired by the candidate list matches the identifier of the UE 100-2 that transmits the discovery signal.

Further, when the UE 100-2 notifies the eNB 200 or the network 500 of the blacklist on the refused UE that is refused to be discovered as a partner of the D2D communication and the blacklist is registered in the discovery list, if the UE 100-1 is a UE 100 included in the blacklist, then the eNB 200 may determine that the two identifiers do not match even when the identifier of a UE 100-3 acquired by the candidate list matches the identifier of the UE 100-2 that transmits the discovery signal registered in the discovery list. In this case, the process in step 411 is not executed but the process in step 421 described later is executed.

Further, when the UE 100-2 notifies the eNB 200 or the network 500 of fact that the communication partner of the D2D communication is not limited to a specific user terminal and the fact is registered in the discovery list, the eNB 200 may execute the process in step 411 even when the identifier of the UE 100-2 acquired by the candidate list does not match the identifier of the UE 100 that transmits the discovery signal.

In step 411, the eNB 200 generates a second discovery list (DiscoveryList2) destined to the UE 100-1. The second discovery list is a list obtained by extracting the UE 100 set by the UE 100-1 to the candidate list from the discovery list (first discovery list) provided in the eNB 200. The eNB 200 registers the identifier (UEID 100-2) of the UE 100-2 and the discovery code Dis1 in the second discovery list.

In step 412, the eNB 200 transmits discovery signal information including the second discovery list, to the UE 100-1. The UE 100-1 receives the discovery signal information.

In order that the UE 100-2 is known that the discovery signal information including the UE 100-2 is transmitted, the eNB 200 may transmit the discovery signal information also to the UE 100-2, and in order to control so that the UE 100-2 does not perform the standby setting in step 413, the eNB 200 may not need to transmit the discovery signal information also to the UE 100-2.

In step 413, in much the same way as in step 103 of the first embodiment, the UEID 100-1 performs the standby setting for starting the scanning of the discovery signal on the basis of the discovery code Dis1.

In step 414, in much the same way as in step 104 of the first embodiment, the UE 100-2 broadcasts the discovery signal including the discovery code Dis1. The UE 100-1 receives the discovery signal through the scanning of the discovery signal.

In step 415, the UE 100-1 discovers the discovery code Dis1 through receiving the discovery signal. As a result, the UE 100-1 displays in a pop-up manner in the user interface 120 that the user Usr2 is detected.

Thereafter, the UE 100-1 establishes a connection for the D2D communication with the UE 100-2, and the UE 100-1 and the UE 100-2 start the D2D communication.

On the other hand, as shown in FIG. 14, the UE 100-1 sets (registers) to the candidate list an identifier of a user Usr3 and an identifier UEID 100-3 of the UE 100-3 that is the UE held by the user Usr3, the eNB 200 determines that the identifier of the UE 100-3 acquired by the candidate list does not match the identifier of the UE 100-2 that transmits the discovery signal registered in the discovery list, and executes the process in step 421.

In step 421, the eNB 200 creates a message to a fact that there is no matching identifier (UEID) destined to the UE 100-1. For example, the eNB 200 creates an empty message.

In step 422, the eNB 200 transmits the discovery signal information including the empty message created in step 421, to the UE 100-1. The UE 100-1 receives the discovery signal information.

In step 423, the UE 100-1, the UE 100-1 does not start the scanning of the discovery signal, and thus, performs a setting to not stand by the discovery signal. Therefore, in the UE 100-1, the scanning of the discovery signal is still limited.

### Summary of Second Embodiment

In the present embodiment, the UE 100-1 sets the unique identifier of the desired UE, to the candidate list. The UE 100-1 notifies the eNB 200 of the unique identifier of the desired UE. The eNB 200 notifies the UE 100-1 of the information related to the UE 100-2 as the discovery signal information when the unique identifier of the desired UE matches the identifier of the UE 100-2 that transmits the discovery signal, and/or notifies the fact (empty message) that the unique identifier of the desired UE does not match the identifier of the UE 100-2 that transmits the discovery signal when the unique identifier of the desired UE does not match the identifier of the UE 100-2 that transmits the discovery signal. As a result, the UE 100-1 is capable of acquiring, as the discovery signal information, only the information related to the desired UE. Further, when the empty message is notified, the UE 100-1 is capable of recognizing that the desired UE does not transmit the discovery signal, and thus, it is not necessary to perform the scanning of the wasteful discovery signal and it thus is possible to restrain a battery consumption.

Further, in the present embodiment, the UE 100-2 notifies the eNB 200 of a whitelist relating to the accepted UE. Only when the UE 100-1 that notifies the desired UE is the accepted UE included in the whitelist, the eNB 200 notifies the UE 100-1 of the information on the UE 100-2 as the discovery signal. Further, in the present embodiment, the UE 100-2 notifies the eNB 200 of a blacklist relating to the refused UE. Only when the UE 100-1 that notifies the desired UE is the refused UE included in the blacklist, the eNB 200 does not notify the UE 100-1 of the information on the UE 100-2 as the discovery signal. As a result, the UE 100-2 is capable of avoiding a situation where the information on the UE 100-2 is received by the UE that does not desire the D2D communication.

Further, in the present embodiment, the UE 100-2 notifies the eNB 200 of the fact that the communication partner of the D2D communication is not limited to a specific user. Even when the identifier of the desired UE does not match the identifier of the UE 100-2 that transmits the discovery signal, the eNB 200 notifies the UE 100-1 of the information on the UE 100-2 as the discovery signal information. As a result, a UE 100 not registered in the candidate list as the desired UE is capable of scanning the discovery signal, and thus, the UE 100-2 is capable of effectively utilizing the D2D communication.

### OTHER EMBODIMENTS

As described above, the present invention has been described with the embodiments. However, it should not be understood that those descriptions and drawings constituting a part of the present disclosure limit the present invention. From this disclosure, a variety of alternate embodiments, examples, and applicable techniques will become apparent to one skilled in the art.

For example, in the above-described first embodiment, the UE 100-1 sets, as the information for designating the desired UE that is desired to be the communication partner of the D2D communication, the application identifier AP1; however, this is not limiting.

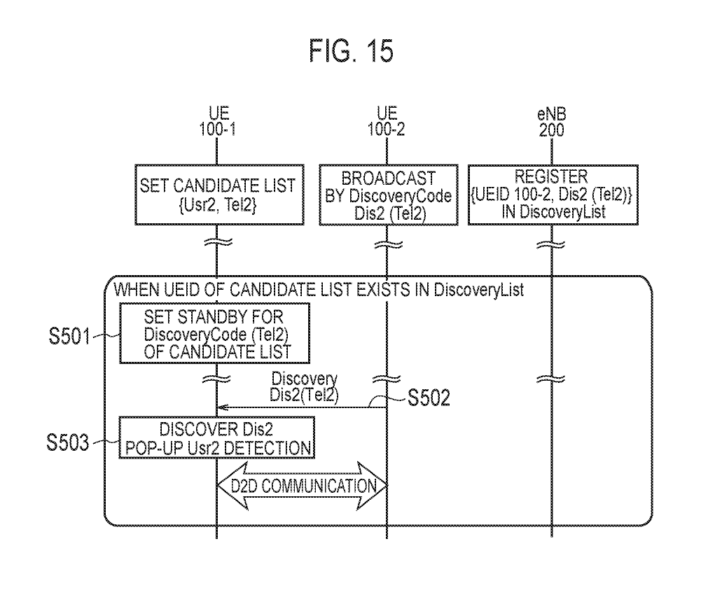

As shown in FIG. 15, the UE 100-1 may set, as the unique identifier indicating the UE 100-2 and indicating the desired UE, a well-known unique identifier (telephone number Tel2, for example) to the UE 100-1. The UE 100-2 starts broadcasting the discovery signal including the Tel2 as a discovery code Dis2. The eNB 200 registers the identifier (UEID 100-2) of the UE 100-2 and the Tel2 as the discovery code Dis2 in the discovery list. It is noted that although omitted, the eNB 200 broadcasts that the discovery code Dis2 is the Tel2 which is included into the discovery signal information. The UE 100-1 receives the discovery signal information.

In step 501, the set telephone number Tel2 exists in the discovery signal information, and thus, as the discovery code Dis2 of the candidate list, the UE 100-1 performs the standby setting for starting scanning the discovery signal, on the basis of the Tel2.

In step 502, the UE 100-2 broadcasts the discovery signal including the discovery code Tel2. The UE 100-1 receives the discovery signal through the scanning of the discovery signal.

In step 503, the UE 100-1 discovers the discovery code Tel2 through receiving the discovery signal. As a result, the UE 100-1 displays in a pop-up manner in the user interface 120 that the user Usr2 is detected.

Thereafter, the UE 100-1 establishes a connection for the D2D communication with the UE 100-2, and the UE 100-1 and the UE 100-2 start the D2D communication.

Thus, the UE 100-1 sets the telephone number of the UE 100-2 well-known to the UE 100-1 to the candidate list, the UE 100-2 transmits, as the discovery code, the telephone number (that is, the telephone number well-known to the UE 100-1) of the UE 100-2 itself which is included into the discovery signal, and when the telephone number included in the discovery signal matches the telephone number set to the candidate list, the UE 100-1 determines that the UE 100-2 that transmits the discovery signal is the desired UE. As a result, the UE 100-1 is capable of determining whether or not the UE 100-2 that transmits the discovery signal is the desired UE without a need of inquiring the eNB 200 or the network 500. Consequently, the UE 100-1 may not need to inquire the eNB 200 or the network 500, and thus, it is possible to restrain a battery consumption.

It is noted that the identifier that is regarded by the UE 100-2 as the discovery code may be an email address, for example as well as the telephone number of itself.

It is noted that when the UE 100-1 receives the discovery signal including the Tel2 as the discovery code Dis2 from the UE 100-2 before receiving the discovery signal information, the UE 100-1 knows that the Tel2 indicates the UE 100-2, and thus, the UE 100-1 is capable of recognizing the transmission source without a need of confirming, by the discovery signal information, the transmission source of the discovery signal. Therefore, when the UE 100-2 transmits the discovery signal by using the telephone number (the unique identifier of the UE 100-2 well-known to the UE 100-1), the UE 100-2 is capable of omitting a process of designating the transmission source of the discovery signal by the reception of the discovery signal and the discovery signal information.

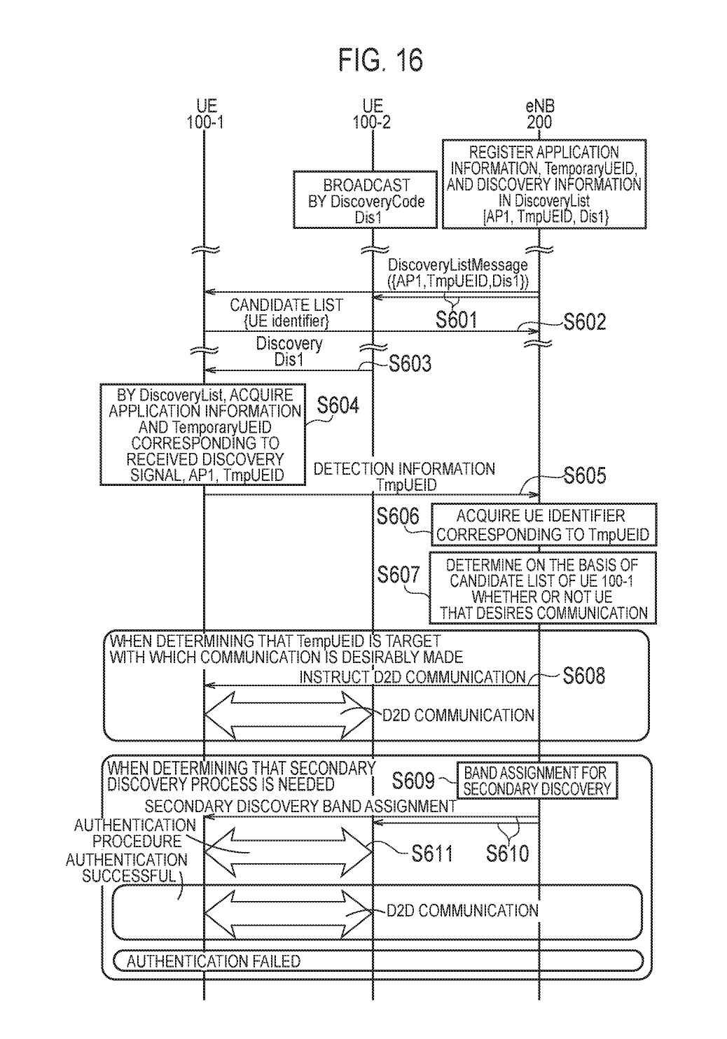

Further, in the modification of the above-described first embodiment, the network 500 has the candidate list of the UE 100-1; however, this is not limiting. As shown in FIG. 16, the UE 100-1 may notify the eNB 200 of the candidate list where necessary (see step 602). For example, the UE 100-1 may transmit the candidate list to the eNB 200 when receiving the discovery signal information.

It is noted that steps 601 and 603 to 611 correspond to steps 201 to 208, 211, 221, and 223 in the modification of the first embodiment (see FIG. 10).

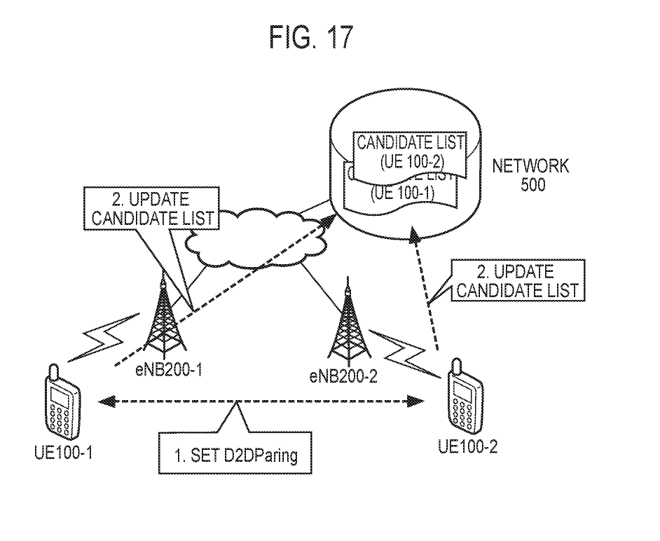

Further, as shown in FIG. 17, the UE 100-1 and the UE 100-2 may perform a D2D pair setting before registering the mutual UE identifiers to the candidate list, and each of the UE 100-1 and the UE 100-2 may notify that the candidate list is to be updated by way of the eNB 200.

The network 500 updates the candidate list of each of the UE 100-1 and the UE 100-2. Specifically, the network 500 registers the identifiers of the respective UEs 100 to the candidate list of each of the UE 100-1 and the UE 100-2.

Further, in the first embodiment, the UE 100 registered in the discovery list is a UE 100 that exists in the cell managed by the eNB 200; however, this is not limiting. It may be possible to register the UE 100 that exists in an area (neighboring cell) managed by a neighboring eNB 200 in the neighborhood of the eNB 200, into the discovery list. The eNB 200 may acquire, via an X2 interface from the neighboring eNB 200, the discovery list in which the UE 100 that exists in the neighboring cell is registered.

Further, in the modification of the above-described first embodiment, the eNB 200 performs the determination; however, an upper device of the eNB 200 or a determination device (server) on a network may perform the determination, for example.

Further, in the above-described first and second embodiments, the UE 100 starts the scanning when the limitation on the scanning is released; however, this is not limiting. For example, the UE 100 may lengthen a scanning interval when performing the scanning and then the limitation on the scanning is released.

Further, in the above-described second embodiment, in steps 421 and 422, the eNB 200 creates the empty message destined to the UE 100-1 and transmits the empty message to the UE 100-1; however, this is not limiting. When determining that the identifier of the UE 100-3 acquired by the candidate list of the UE 100-1 does not match the identifier of the UE 100-2 that transmits the discovery signal registered in the discovery list, the eNB 200 may end the process. The UE 100-1 recognizes that the UE 100-3 does not transmit the discovery signal when no information is notified from the eNB 200. Further, in the above-described first embodiment, the UE 100-1 previously sets the information on the desired UE to the candidate list before receiving the discovery signal information; however, this is not limiting. The UE 100-1 may set the information on the desired UE to the candidate list on the basis of the information included in the discovery signal information after receiving the discovery signal information. For example, the UE 100-1 may set, after recognizing by the discovery signal information that there is the UE 100 that uses a desired application for the D2D communication, the application to the candidate list, or may set, after recognizing by the discovery signal information that there is the desired UE 100, the identifier of the desired UE 100 to the candidate list. The UE 100-1 releases the limitation on the scanning of the discovery signal after setting these settings to the candidate list.

In addition, the entire content of Japanese Patent Application No. 2013-144024 (filed on Jul. 9, 2013) is incorporated in the present specification by reference.

### INDUSTRIAL APPLICABILITY

With a mobile communication system, a user terminal, and a network apparatus according to the present invention, it is possible to restrain wasteful battery consumption in D2D communication.

1. A mobile communication system that supports D2D communication that is direct Device-to-Device communication, comprising:
a user terminal that controls scanning of a discovery signal used for discovering a partner terminal of the D2D communication; and
a network apparatus that notifies the user terminal of discovery signal information on a different user terminal that transmits the discovery signal within an area where the user terminal exists, wherein
the user terminal sets desired terminal information for designating a desired user terminal that is desired to be a communication partner of the D2D communication, and
the user terminal limits scanning of the discovery signal until determining that the desired terminal information is included in the discovery signal information notified from the network apparatus.

2. The mobile communication system according to claim 1, wherein
the user terminal sets, as the desired terminal information, an application identifier indicating an application used for the D2D communication, and
when an application identifier that is included in the discovery signal information and that indicates an application used by the different user terminal for the D2D communication matches the application identifier that is set, the user terminal determines that the desired terminal information is included in the discovery signal information.

3. The mobile communication system according to claim 1, wherein
the user terminal sets, as the desired terminal information, a unique identifier indicating the desired user terminal,
the user terminal notifies the network apparatus of the unique identifier indicating the desired user terminal as the desired terminal information, and
when the unique identifier acquired by the desired terminal information matches an identifier indicating the different user terminal that transmits the discovery signal, the network apparatus notifies the user terminal of information related to the different user terminal as the discovery signal information, and/or, when the unique identifier acquired by the desired terminal information does not match the identifier indicating the different user terminal that transmits the discovery signal, notifies the user terminal of information indicating that a desired user terminal does not match the different user terminal.

4. The mobile communication system according to claim 3, wherein
the different user terminal notifies the network apparatus of a whitelist relating to an accepted user terminal that is accepted to be discovered as a communication partner of the D2D communication, and
only when the user terminal that notifies the desired terminal information is the accepted user terminal included in the whitelist, the network apparatus notifies the user terminal of information relating to the different user terminal as the discovery signal information.

5. The mobile communication system according to claim 3, wherein
the different user terminal notifies the network apparatus of a blacklist relating to a refused user terminal that is refused to be discovered as a communication partner of the D2D communication, and
when the user terminal that notifies the desired terminal information is the refused user terminal included in the blacklist, the network apparatus does not notify the user terminal of information relating to the different user terminal as the discovery signal information.

6. The mobile communication system according to claim 3, wherein
the different user terminal notifies the network apparatus fact that the communication partner of the D2D communication is not limited to a specific user terminal, and
even when the unique identifier acquired by the desired terminal information does not match the identifier indicating the different user terminal that transmits the discovery signal, the network apparatus notifies the user terminal of information relating to the different user terminal as the discovery signal information.

7. The mobile communication system according to claim 1, wherein
the user terminal notifies the network apparatus of a unique identifier indicating the desired user terminal,
the network apparatus transmits a temporary user identifier temporarily assigned as an identifier indicating the different user terminal, which is included in the discovery signal information,
when receiving the discovery signal from the different user terminal through scanning of the discovery signal and the temporary user identifier corresponding to the discovery signal is designated on the basis of the discovery signal information, the user terminal notifies the network apparatus of the temporary user identifier, and
when a unique identifier of the different user terminal to which the temporary user identifier is assigned matches a unique identifier indicating the desired user terminal, the network apparatus notifies the user terminal of an instruction to start the D2D communication, and/or, when a unique identifier of the different user terminal to which the temporary user identifier is assigned does not match a unique identifier indicating the desired user terminal, the network apparatus notifies the user terminal of information indicating that the unique identifier of the different user terminal does not match the unique identifier indicating the desired user terminal.

8. The mobile communication system according to claim 1, wherein
the user terminal notifies the network apparatus of a unique identifier indicating the desired user terminal,
the different user terminal transmits a temporary user identifier temporarily assigned as an identifier indicating the different user terminal, which is included into the discovery signal,
when receiving the discovery signal including the temporary user identifier from the different user terminal through scanning of the discovery signal, the user terminal notifies the network apparatus of the temporary user identifier, and
when a unique identifier of the different user terminal to which the temporary user identifier is assigned matches a unique identifier indicating the desired user terminal, the network apparatus notifies the user terminal of an instruction to start the D2D communication, and/or, when a unique identifier of the different user terminal to which the temporary user identifier is assigned does not match a unique identifier indicating the desired user terminal, the network apparatus notifies the user terminal of information indicating that the unique identifier of the different user terminal does not match the unique identifier indicating the desired user terminal.

9. The mobile communication system according to claim 1, wherein
when receiving the discovery signal from the different user terminal through scanning of the discovery signal, the user terminal notifies the network apparatus of a fact that the discovery signal is received,
the network apparatus that receives the fact that the discovery signal is received notifies the user terminal and the different user terminal of a radio resource assigned to the user terminal and the different user terminal, and
the user terminal and the different user terminal confirm whether or not to start the D2D communication by using the radio resource.

10. The mobile communication system according to claim 9, wherein
the network apparatus determines, on the basis of an application used by the different user terminal for the D2D communication, whether or not to notify the user terminal and the different user terminal of the radio resource.

11. The mobile communication system according to claim 1, wherein
the user terminal sets, as the desired terminal information, a unique identifier that indicates the different user terminal and that is known by the user terminal,
the different user terminal transmits the unique identifier that indicates the different user terminal and that is known by the user terminal, which is included in the discovery signal, and
when the unique identifier included in the discovery signal matches the unique identifier set as the desired terminal information, the user terminal determines that the different user terminal that transmits the discovery signal is the desired user terminal.

12. A user terminal in a mobile communication system that has a network apparatus and that supports D2D communication that is direct Device-to-Device communication, comprising:
a controller configured to control scanning of a discovery signal used for discovering a partner terminal of the D2D communication; and
a receiver configured to receive, from the network apparatus, discovery signal information on a different user terminal that transmits the discovery signal within an area where the user terminal exists, wherein
the controller sets desired terminal information for designating a desired user terminal that is desired to be a communication partner of the D2D communication, and
the controller limits scanning of the discovery signal until the user terminal determines that the desired terminal information is included in the discovery signal information notified from the network apparatus.

13. The user terminal according to claim 12, wherein
the controller sets, as the desired terminal information, an application identifier indicating an application used for the D2D communication, and
when an application identifier that is included in the discovery signal information and that indicates an application used by the different user terminal for the D2D communication matches the application identifier that is set, the controller determines that the desired terminal information is included in the discovery signal information.

14. The user terminal according to claim 12, further comprising: a transmitter configured to notify the network apparatus of the unique identifier indicating the desired user terminal as the desired terminal information, wherein
when the unique identifier acquired by the desired terminal information matches an identifier indicating the different user terminal that transmits the discovery signal, the receiver receives from the network apparatus information relating to the different user terminal as the discovery signal information and/or, when the unique identifier acquired by the desired terminal information does not match the identifier indicating the different user terminal that transmits the discovery signal, receives, from the network apparatus, information indicating that the desired user terminal does not match the different user terminal as the discovery signal information.

15. A network apparatus in a mobile communication system that has a user terminal and that supports D2D communication that is direct device-to-device communication, comprising:
a transmitter configured to notify the user terminal of discovery signal information on a different user terminal that transmits the discovery signal within an area where the user terminal exists, wherein
the discovery signal information is used by the user terminal to determine whether or not a desired user terminal that is desired by the user terminal to be a communication partner of the D2D communication transmits the discovery signal within the area.

16. The network apparatus according to claim 15, wherein
the transmitter notifies the user terminal of the discovery signal information including an application identifier indicating an application used by the different user terminal for the D2D communication, and
the application identifier included in the discovery signal information is used by the user terminal to determine whether or not the application used by the different user terminal for the D2D communication matches the application used by the user terminal for the D2D communication.

17. The network apparatus according to claim 15, comprising:
a receiver configured to receive a unique identifier indicating the desired user terminal from the user terminal; and
a controller configured to control to, when the unique identifier indicating the desired user terminal matches an identifier indicating the different user terminal that transmits the discovery signal, notify the user terminal of information related to the different user terminal as the discovery signal information, and/or, when the unique identifier acquired by the desired terminal information does not match the identifier indicating the different user terminal that transmits the discovery signal, notify the user terminal of information indicating that a desired user terminal does not match the different user terminal, as the discovery signal information.
